(19) United States
(12) Patent Application Publication
(10) Pub. No.: US 2013/0195201 A1
(43) Pub. Date: Aug. 1, 2013

(54) TECHNIQUES FOR LAYERED VIDEO ENCODING AND DECODING

(71) Applicants: Jill Boyce, Manalapan, NJ (US); Danny Hong, New York, NY (US); Won Kap Jang, Edgewater, NJ (US); Stephan Wenger, Hillsborough, CA (US)

(72) Inventors: Jill Boyce, Manalapan, NJ (US); Danny Hong, New York, NY (US); Won Kap Jang, Edgewater, NJ (US); Stephan Wenger, Hillsborough, CA (US)

(73) Assignee: Vidyo, Inc., Hackensack, NJ (US)

(21) Appl. No.: 13/738,138

(22) Filed: Jan. 10, 2013

Related U.S. Application Data
(60) Provisional application No. 61/585,120, filed on Jan. 10, 2012.

(51) Int. Cl. H04N 7/26

(52) U.S. Cl. CPC H04N 19/00424
USPC 375/240.25

(57) ABSTRACT

A method for video decoding includes: decoding information including a description of a layer hierarchy including, for each layer, a layer_id, a reference_layer_id, and a dependent_flag; decoding for at least one access unit, a plurality of layer_not_present_flags, where each layer_not_present_flag is associated with at least one layer; and decoding Slice Network Abstraction Layer (NAL) units belonging to those layer(s) where the associated layer_not_present flag is not set.

This application claims priority to U.S. provisional patent application Ser. No. 61/585,120, filed Jan. 10, 2012, titled “Techniques for Layered Video Encoding and Decoding”, and U.S. patent application Ser. No. 13/539,864, filed Jul. 2, 2012, titled “Improved NAL Unit Header,”, and U.S. patent application Ser. No. 13/539,900, filed Jul. 2, 2012, titled “Dependency Parameter Set for Scalable Video Coding”, the disclosure of each of which are incorporated by reference herein in their entireties.

### FIELD

This application relates to video compression, and more particularly to methods for scalable/multiview/simulcast video encoding and decoding where two or more layers are used to represent a given video signal.

### BACKGROUND

Commercial video compression techniques can use video coding standards to allow for cross-vendor interoperability. For example, see ITU-T Rec. H.264, “Advanced video coding for generic audiovisual services”, March 2010, available from the International Telecommunication Union (“ITU”), Place de Nations, CH-1211 Geneva 20, Switzerland or http://www.itu.int/rec/T-REC-H.264, and incorporated herein by reference in its entirety.

An initial version of H.264 was ratified in 2003, and included coding tools, for example a flexible reference picture selection model, that allows for temporal scalability. A subsequent version, ratified in 2007, added in Annex G an extension towards scalable video coding (SVC), including techniques for spatial scalability and quality scalability, also known as signal-to-noise (SNR) scalability. Yet another version ratified in 2009, included in Annex H multi-view coding (MVC).

Earlier versions of H.264 were designed without paying special regards to the requirements of later versions. This has resulted in certain shortcomings, for example:

(1) In the design of the Network Adaptation Layer (NAL) Unit header: a not seamlessly backward compatible extension mechanism to signal layers was “bolted on”, that can be inefficient.

(2) In the slice header: the non-scalable H.264 slice header could not be organically extended with certain syntax elements, which, therefore, was included in retrofit structures such as parts of the NAL unit header extension or the prefix NAL unit.

(3) In the design of a information that summarizes a layer structure, i.e. the scalability information SEI message: this SEI message was non-normative, implying that a decoder should not rely on it (the SEI message may not have been created by the encoder). As a result, obtaining knowledge of the layer structure typically required deep bitstream inspection with potentially many Access Units (AUs) look ahead, which is suboptimal for a low delay system such as a video conferencing system.

(4) In the design of information indicating a target layer, which can be used by a decoder to identify which NAL units of a scalable bitstream it should be concerned about: no such information was available in SVC.

(5) In the design of a bitstream that allows for simulcast, i.e. containing more than one base layer: no such information was available in SVC.

Co-pending U.S. patent application Ser. No. 13/539,864 addresses, among other things, an improved NAL unit header.

U.S. patent application Ser. No. 13/539,900, describes a Dependency Parameter Set (DPS), which can be used to summarize a layer structure.

Throughout the disclosure, syntax table diagrams following the conventions specified in H.264 are being used. To briefly summarize those conventions, a C-style notation is used. A boldface character string refers to a syntax element fetched from the bitstream (which can consist of NAL units separated by, for example, start codes or packet headers). The “Descriptor” column of the syntax diagram table provides information of the type of data. For example, u(2) refers to an unsigned integer of 2 bits length, f(1) refers to a single bit of a predefined value.

Techniques for High Efficiency Video Coding (HEVC) have been considered for standardization. A working draft of HEVC can be found at (B. Bross et. al., “High Efficiency Video Coding (HEVC) text specification draft 9”, available from http://phenix.int-evry.fr/jct/doc_end_user/documents/11_Shanghai/wg11/JCTVC-K 1003-v13.zip), December 2012, referred to as “WD9” henceforth, which is incorporated herein by reference in its entirety. HEVC inherits many high level syntax features of H.264.

### SUMMARY

The disclosed subject matter provides for techniques to enable efficient high layer scalable video coding, decoding, and processing in a Media-Aware Network Element (MANE).

In one embodiment, a decoder receives a set of layer not present flags indicating, for example for each layer described in the table of layer descriptions in the Dependency Parameter Set (DPS), whether that layer is present in an Access Unit.

In the same or another embodiment, the decoder can use the layer not present flags to decide (among other factors) whether a NAL unit is to be decoded.

In the same or another embodiment, the decoder can use a layer for inter layer prediction that is indirectly identified by the absence of a layer that would be the default inter layer prediction layer, as signaled by a layer not present flag set to 1.

In the same or another embodiment, an encoder creates a scalable bitstream usable by the aforementioned decoder.

In the same or another embodiment, a Media-Aware Network Element (MANE) removes NAL units belonging to a layer based on values of at least one layer not present flag.

In the same or another embodiment, a MANE can remove NAL units belong to a layer based on factors such as insufficient bandwidth, and can modify at least one layer not present flag so to reflect the removed NAL units.

In the same or another embodiment, the not present flags can be part of the syntax of at least one of an Access Unit Delimiter, a layer not present NAL unit, a GOP, Picture, Slice header.

### BRIEF DESCRIPTION OF THE DRAWINGS

FIG. 1 presents a dependency parameter set and a NAL unit header referring to it.

FIG. 2A-D presents a graphical representation of a layer description in a DPS, two layer structures based on the DPS, and the corresponding layer not present flag settings.

FIG. 3 presents a flowchart of an exemplary decoder operation in accordance with an embodiment of the disclosed subject matter.

FIG. 4 shows an exemplary computer system for video coding in accordance with an embodiment of the disclosed subject matter.

FIG. 5 shows a system for video coding and decoding in accordance with an embodiment of the disclosed subject matter.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

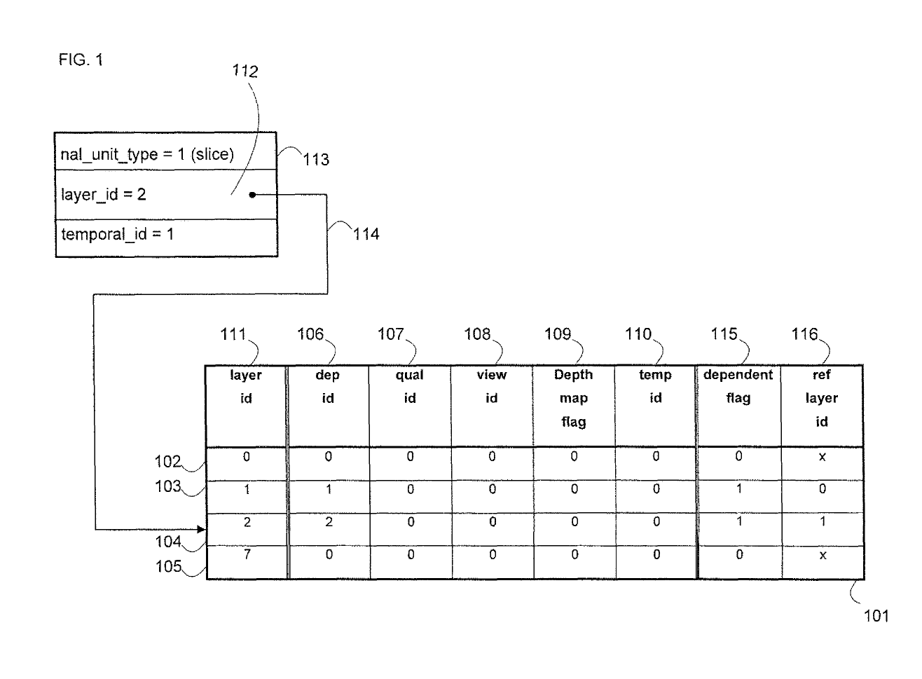

FIG. 1 shows the structures that, jointly, allow for a representation of a complex layered bitstream that can include different layer types, simulcast representations (also referred to herein as simulcast layers), multiple views, depth maps, and so forth.

A dependency parameter set, as described herein, and in U.S. Ser. No. 13/539,900, can include a layer description table (101), as also described in Ser. No. 13/539,864. The layer description table can include a plurality of entries; four entries are shown (102, 103, 104, 105). Each entry can include syntax elements describing the layer, such as, for example, dependency_id (106), quality_id (107), view_id (108) and depth_map_flag (109). In combination, those syntax elements can define a layer as a spatial or SNR or quality or view layer or depth map. The layer description can in some cases also include a temporal_id, (110) as described in Ser. No. 13/539,864, in which case the layer definition includes temporal layers.

The layer description can further include a layer_id (111) as described in Ser. No. 13/539,864, which can be used to reference (114) the layer from other syntax elements such as the layer_id (112) in the NAL unit header (113).

The layer_id can further include two syntax elements that can be used to establish a hierarchy of layer dependencies; that is, information describing which layer is dependent on which other layer. These two syntax elements can be a dependent_flag (115) and a ref_layer_id (116).

A layer can be a dependent or independent layer, as indicated by dependent_flag (115). A value of 1 for dependent_flag (115) can indicate that the layer depends on another layer, and that other layer can be identified by a ref_layer_id (116) by its layer_id. For example, table entry (103) has the dependent_flag (115) set to 1, indicating that the layer described by table entry (103) is dependent on another layer. That layer is identified by value 0 of the reference_layer_id (116), which in this example is 0, and thereby referring to the entry (102) which has a layer_id of 0.

The ref_layer_id syntax element may be valid, i.e. populated with a meaningful value, when the dependent_flag is set. If the dependent_flag is not set, i.e. its value is 0, the ref_layer_id is undefined, as indicated by the letter “x” in entries (102) and (105).

This single-level dependency can be used recursively. For example, the layer identified by entry (104) depends on the layer defined by entry (103), which in turn depends on a layer defined by entry (102). Such a referencing mechanism can be used to model complex layer structures, limited by factors such as the layer description table size and/or the numbering range of the layer_id syntax element.

The coding of the ref_layer_id syntax element can, for example be absolute, indicating the layer_id of the reference layer directly, or differential, between the layer_id of the referencing layer_id and the layer_id that is being referred to.

A value of 0 for dependent_flag can indicate that the layer does not depend on any other layer, i.e. it can be decoded independently of other layers. Such a layer can be a base layer in a layered bitstream in the traditional sense, which can include only a single base layer. However, it can also indicate a simulcast (base) layer (which can be referred to by simulcast enhancement layer(s)), a view, and so on. Layer description table (101) contains two such independent layer descriptions, namely entries (102) and (105) respectively.

Each layer can have an associated layer set, which can include that layer plus any reference layers which that layer is dependent upon, if any. The layer set of the layer described by entry (102) contains the layers described by entries (103) and (104) (as they are referring, directly or indirectly, to layer (102). Layer (105) does not have dependent layers.

As previously described a layer set is defined as containing exactly one independent layer and zero or more dependent layers.

The table of layer descriptions can, for example, be part of a Dependency Parameter Set, as described, for example in co-pending U.S. patent application Ser. No. 13/539,900. The layer referencing mechanism from a NAL unit header has been described in more detail in Ser. No. 13/539,864. As also described therein, the temporal_id can either be part of the NAL unit header (in which case temporal layers can be sub-layers of the layer identified by the layer_id), or it can be part of the layer description (in which case a temporal layer fully qualifies as a layer).

Each non-temporal layer can refer (for example indirectly, through the PPS-id in the slice header that references the SPS-id, as described in WD9) separately to a sequence parameter set, which can be used to defined layer properties such as spatial resolution. Several layers can refer to the same sequence parameter sets, or different sequence parameter sets.

Similar to the parameter sets in WD9, also the DPS can require “activation”, which can follow a similar mechanism as described in WD9 for SPS and PPS. Activation can be, for example, implicit at the beginning of a sequence, as defined in WD9 (starting with an IDR picture). There can be a single DPS, which is implicitly activated at the start of a sequence, or there can be a table of DPSs, and the selection of the to be activated DPS can occur, for example, through a value in a Group of Picture header, Picture Header, Slice header, or through indirection mechanism from, for example, the slice header similar to the activation of a SPS 9 as described in WD9).

A single DPS may be active at a time and the active DPS may apply to all pictures of all layers of an entire video sequence. Because once a DPS is activated it can apply to an entire coded sequence, its inter-layer dependency (expressed in the table of layer descriptions) is consistent for the entire coded sequence. Restricting the DPS to stay fixed over the entire sequence can restrict the worst-case number of layers, types of layers, and number of layer dependencies, which can result in simpler and more cost effective decoder implementation and operation. For example, the allocation of memory for reference pictures and data structures can generally be performed only once per sequence.

As described in more detail in Ser. No. 13/539,864, the layer id can be ordered numerically such that, for any given layer, dependent layers have, for example, a numerically higher layer_id. This can allow for removal of NAL units of layers not needed for decoding a target layer, by removing all NAL units with a layer_id numerically higher than the target layer. A target layer can be selected by an application. For example, it can make sense not to decode a spatial enhancement layer which offers a higher resolution than the screen resolution of a device that includes the decoder. In such a case, the target layer can be a layer lower in the layer hierarchy than the highest layer. The target layer can also be influenced by other factors. For example, if a receiver identifies that a layer is damaged, it may be advantageous to stop the decoding of that layer and all layers that depend on it. This can be in effect a change of the target layer to the lowest layer in the layer hierarchy that is undamaged. A MANE can also adjust the target layer, for example if the MANE's outgoing network connection doesn't have enough bandwidth available to transport all layers the MANE receives.

Described now are the identification of target layer in a video bitstream, and dependent layer management.

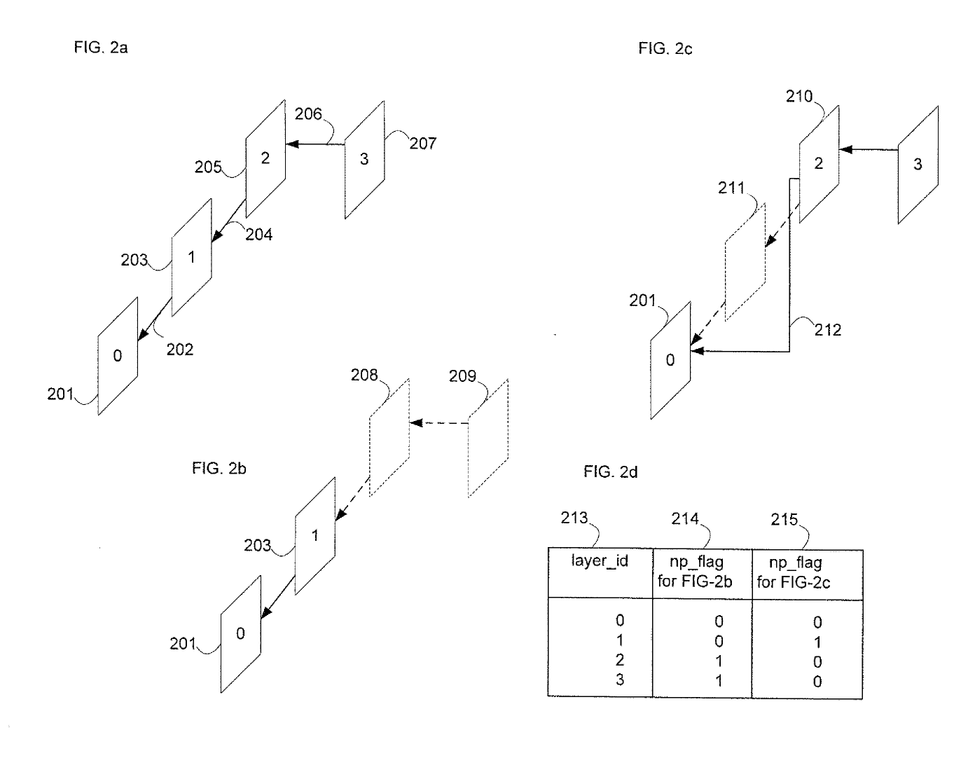

Referring to FIG. 2a, the DPS and its included layer description table can define the relationship of all possible layers and/or layer combinations that can be decoded jointly so to create a reconstructed video sequence. For example, a base layer (201) may be referred to (202) by a first enhancement layer (203), which in turn is being referred to (204) by a third enhancement layer (205). The references (202) and (204) can, for example be spatial enhancement layer references. A fourth enhancement layer (207) refers (206) to layer (205). A possible value of layer_id of each layer is shown in the rhomb representing each layer; for example, layer (203) has a layer_id of 1.

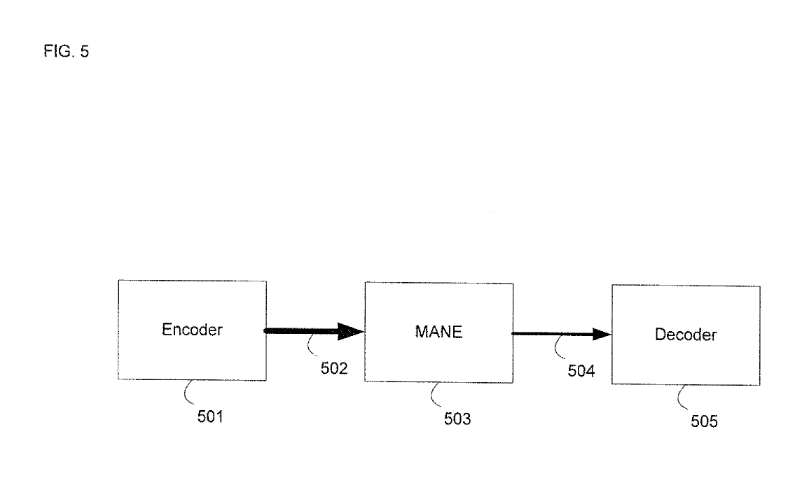

In some cases, a decoder may not wish to decode all layers, for example, because it is not a multiview-capable decoder or is not using a 3D display, it does not have the screen size to meaningfully display a large spatial enhancement layer resolution, it may not have the computational resources to decode a high quality or temporal layer, and so forth. Similarly, MANEs may be forced to remove certain layers from a scalable bitstream so, for example, to stay within bandwidth limitations and/or so not to send enhancement layer data that depends on a layer that is known to be corrupted, for example by packet loss. Referring to FIG. 5, consider a scenario where an encoder (501) sends a scalable bitstream (502) containing a certain number of layers (depicted by a fat arrow) to a MANE (503), the MANE (503) removes certain layers of the scalable bitstream based on factors such as network congestion, packet loss, user requirements known by the MANE (503) but not by the encoder (501), and so on, and sends the modified scalable bitstream (504) (depicted here by a thinner arrow so to show the lower number of layers included in this modified scalable bitstream) to a decoder (505). It can be advantageous to include a mechanism in the scalable bitstream that can identify a “target layer”, also known as “operation point” in, for example, RFC 6190 (available from http://datatracker.ietf.org/doc/rfc6190/, and included herein by reference in its entirety), which can be the highest layer in a layer hierarchy that a decoder is supposed to process. All slice NAL units not belonging to the target layer and/or to layers the target layer depends on, for example through a numerically lower layer_id, can be ignored by a decoder and can be discarded by a MANE.

Shown in FIG. 2b is a layer hierarchy where a target layer of 1 has been specified. The layer hierarchy in the DPS can be the same as in FIG. 2a. However, layers 2 (208) and 3 (209), while present in the DPS ((205) and (207) respectively), may not be in scalable bitstream (i.e. because an encoder didn't place them therein, or because a MANE removed them), or they may be in the scalable bitstream but the decoder is instructed, by encoder, or MANE, or application, not to use them. This can be indicated by an appropriate setting of the layer_not_present_flag (214) in relation to the layer_id (213). By observing the fact that layers with layer_id (213) equal to 2 and 3 are marked as not present through layer_not_present flag values (214), a decoder can infer that the target layer is layer 1 (203).

Further, in some cases, an encoder can encode layers of a given access unit such that they depend directly to a layer that is not the immediate lower neighboring layer of the layer in question, while for other access units, the dependency relationship may be a traditional one where each layer depends directly on its immediate lower neighboring layer. Referring to FIG. 2c, layer 2 (210) is not referring to layer 1 (211) (which is not present, indicated by its dashed outline), but through a direct interlayer prediction relationship (212) from layer 0 (201) that is not coded directly in the DPS. Note that the inter-layer prediction relationships as depicted in FIGS. 2b and 2c can co-exist in the same scalable bitstream but pertain to different access units.

In order to support the use cases of both FIGS. 2b and 2c, and to allow for per access unit switching of target layers and skipped layers (in the sense of layer 211 in FIG. 2c), a mechanism is needed that can signal, per access unit, the presence or absence of each layer for the purpose of inter-layer prediction.

According to the same or another embodiment, an access unit can include, for example all layers permissible according to the table of layer descriptions in the DPS, a layer_not_present_flag. The layer_not_present flag can be set to 0 if a layer is present, and 1 if a layer is not present. The layer can be identified by its layer_id.

Referring to FIG. 2d, shown is a table indicating the layer_not_present_flag values for layer_ids 0 through 3 (213) (which are permissible for the DPS as outlined in FIG. 2a), and for the layer structure of FIG. 2b (214) and FIG. 2c (215) respectively.

When an encoder removes a layer that can, according to the DPS information, be used as a reference layer in a given access unit, the dependencies of other layers in the access unit upon the removed reference layer for that access unit can be modified as has been described in the context of FIG. 2c. In the same or another embodiment, if an access unit reference layer is an independent layer, which can be indicated by dependent flag equal to 0, and is marked (for example: by the encoder) as being not present, which can be indicated by layer_not_present_flag equal to 1, the access unit layer that directly depends upon non-present reference layer can be inferred to be an independent layer.

If an access unit reference layer is itself a dependent layer, with dependent_flag equal to 1, and is marked as being not present, an access unit layer that depends upon it has its reference layer modified to being the reference layer of the not present layer. Expressed in exemplary pseudo-code,

```
When ReferenceLayer_id[ j ] is equal to i
                      and layer_not_present_flag[ i ] is equal to 0,
    if dependent_flag[ i ] equal to 0
          dependent_flag[ j ] is inferred to be equal to 0.
    else
          ReferenceLayer_id[ j ] = ReferenceLayer_id[ i ]
```

In addition to an encoder, in the same or another embodiment, a MANE can modify the layer_not_present flag(s) during its operation, though its options are somewhat more limited than the option of an encoder. A MANE can, for example perform an operation of removing the two highest layers as was described in the context of FIG. 2b, and provide the decoder with the appropriate flag values so to ensure that the decoder is informed early about the non-presence of the removed layers, and can commence decoding without relying on error detection through, for example a timeout.

In the same or another embodiment, the flags can, for example, be part of a layer not present NAL unit specifically included to signal the presence or absence of layers. An encoder or MANE can advantageously place this NAL unit at the start, or close to the start, of an access unit, so to inform the decoder early that certain layers are missing. Redundant copies of the layer not present NAL unit may be placed in other locations in the access unit so to enable error resilient operation (at the expense of a slight increase of delay) in case the first layer not present NAL unit is lost or damaged in transmission from encoder/MANE to decoder.

One NAL unit that can be part of an access unit and that, if present, is always the first NAL unit in the access unit according to H.264 and WD9 is known as the access unit delimiter NAL unit. According to the same or another embodiment, the layer not present flags can be placed into this NAL unit.

Other options for the placement of the layer not present flags include other high level syntax structures such as GOP header, picture header, slice header, or a parameter set that advantageously, can change between pictures, such as the Picture Parameter Set.

In some cases, it can be sensible to allow the repetition of the high level syntax structure containing the layer not present flag(s) so to improve error resilience: if a packet containing the high level syntax structure gets lost, the flag(s) may still be present in redundant copies of the high level syntax structure in other packets. For the same reason, it can be sensible to allow redundant copies of the flags in more than one of the slice headers of a given access unit.

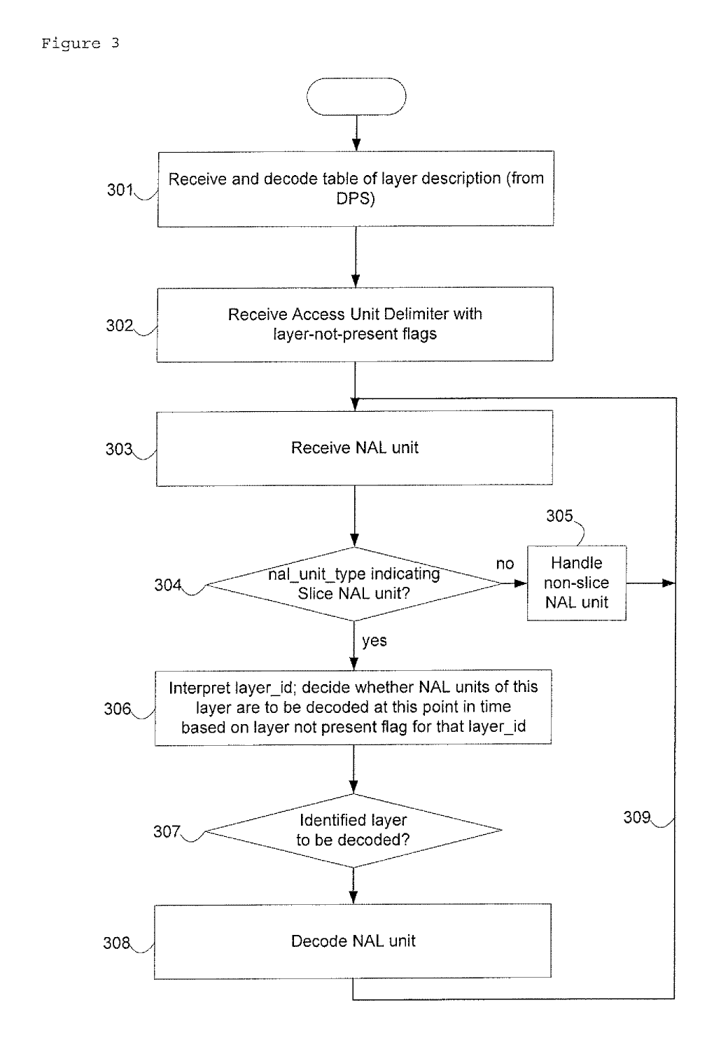

FIG. 3 shows a flow diagram of an example scalable decoder operation using the mechanisms described above.

At the beginning of the decoding of a sequence, in the same or another embodiment, the decoder can receive and decode (301) (and/or activate an already received and/or decoded) a dependency parameter set containing a table of layer descriptions. Reception and activation of the DPS can be similar to reception and activation of other parameter sets, as described, for example, for the PPS and SPS in WD9 and described briefly above.

With the layer description table available, the decoder can start receiving access units. Each access unit can start, for example, with an access unit delimiter that can include the layer not present flags, which can be received and decoded (302), thus establishing knowledge which layers are not present in this access unit.

Now a NAL unit of the access unit can be received (303).

If the NAL unit is not a slice NAL unit (being, for example, a parameter set, SEI message, etc.) (304), then this NAL unit is being dealt with (305).

For slice NAL units, the layer_id in the NAL unit header can be used, among other things as outlined for example in Ser. No. 13/539,864, to check against the corresponding layer not present flag for this layer_id (306). Depending on the layer not present flag for the layer identified by the layer_id (307), the NAL unit may be decoded (308) (if the layer is marked as present according to the flag value) or can be discarded (if the layer is marked as not present according to the flag value).

The mechanism can continue with the next NAL unit (309).

If the end of the access unit is detected, then the mechanism can continue with the reception of the next Access Unit Delimiter. If the end of sequence is detected, then the mechanism can continue with receiving/decoding/activating of the next DPS; neither case is shown.

Certain improvements can be made to improve low delay decoding. Assume a decoder without the disclosed subject matter, that either does not receive the layer not present flag(s) or does not understand them. Further assume that either an encoder or a MANE has removed at least one layer in a given access unit relative to what is advertised in the layering structure information. In order to decode the access unit, the decoder normally would require slice NAL units of all layers. As those are not being received (as they were removed by encoder or MANE), the decoder has to rely on external mechanisms, for example a timeout mechanism or mechanisms based on RTP timestamps and RTP sequence numbers known to those skilled in the art, to identify that it cannot expect slice NAL units for a given layer in a given access unit. After this knowledge has been established, it can start decoding the received layers. The timeout or other external mechanism can add delay, which can be of disadvantage to delay sensitive applications.

Now assume that a decoder knows the target layer it is supposed to decode, for example through the reception of layer not present flags as described above. Further assume that an encoder or MANE has removed at least one layer from a given access unit, and that it described that removal through adequate setting of layer not present flags. As the decoder knows that it does not need to wait for the slice NAL units of the removed layer, it can start decoding immediately after having received the slice NAL units of the layers signaled as present by layer not present flags, thereby avoiding the delay introduced otherwise through timeout or other external mechanism.

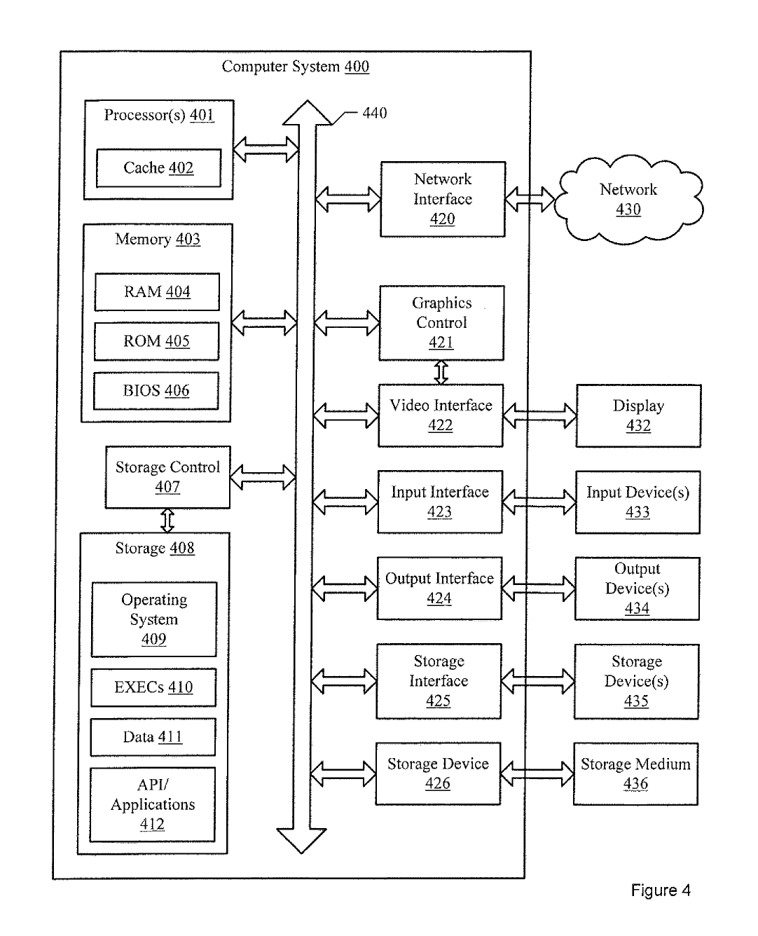

The methods for video coding, described above, can be implemented as computer software using computer-readable instructions and physically stored in computer-readable medium. The computer software can be encoded using any suitable computer languages. The software instructions can be executed on various types of computers. For example, FIG. 4 illustrates a computer system 400 suitable for implementing embodiments of the present disclosure.

The components shown in FIG. 4 for computer system 400 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 400 can have many physical forms including an integrated circuit, a printed circuit board, a small handheld device (such as a mobile telephone or FDA), a personal computer or a super computer.

Computer system 400 includes a display 432, one or more input devices 433 (e.g., keypad, keyboard, mouse, stylus, etc.), one or more output devices 434 (e.g., speaker), one or more storage devices 435, various types of storage medium 436.

The system bus 440 link a wide variety of subsystems. As understood by those skilled in the art, a “bus” refers to a plurality of digital signal lines serving a common function. The system bus 440 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 401 (also referred to as central processing units, or CPUs) optionally contain a cache memory unit 402 for temporary local storage of instructions, data, or computer addresses. Processor(s) 401 are coupled to storage devices including memory 403. Memory 403 includes random access memory (RAM) 404 and read-only memory (ROM) 405. As is well known in the art, ROM 405 acts to transfer data and instructions uni-directionally to the processor(s) 401, and RAM 404 is used typically to transfer data and instructions in a bi-directional manner. Both of these types of memories can include any suitable of the computer-readable media described below.

A fixed storage 408 is also coupled bi-directionally to the processor(s) 401, optionally via a storage control unit 407. It provides additional data storage capacity and can also include any of the computer-readable media described below. Storage 408 can be used to store operating system 409, EXECs 410, application programs 412, data 411 and the like and is typically a secondary storage medium (such as a hard disk) that is slower than primary storage. It should be appreciated that the information retained within storage 408, can, in appropriate cases, be incorporated in standard fashion as virtual memory in memory 403.

Processor(s) 401 is also coupled to a variety of interfaces such as graphics control 421, video interface 422, input interface 423, output interface 424, storage interface 425, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 401 can be coupled to another computer or telecommunications network 430 using network interface 420. With such a network interface 420, it is contemplated that the CPU 401 might receive information from the network 430, or might output information to the network in the course of performing the above-described method. Furthermore, method embodiments of the present disclosure can execute solely upon CPU 401 or can execute over a network 430 such as the Internet in conjunction with a remote CPU 401 that shares a portion of the processing.

According to various embodiments, when in a network environment, i.e., when computer system 400 is connected to network 430, computer system 400 can communicate with other devices that are also connected to network 430. Communications can be sent to and from computer system 400 via network interface 420. For example, incoming communications, such as a request or a response from another device, in the form of one or more packets, can be received from network 430 at network interface 420 and stored in selected sections in memory 403 for processing. Outgoing communications, such as a request or a response to another device, again in the form of one or more packets, can also be stored in selected sections in memory 403 and sent out to network 430 at network interface 420. Processor(s) 401 can access these communication packets stored in memory 403 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 400 can provide functionality as a result of processor(s) 401 executing software embodied in one or more tangible, computer-readable media, such as memory 403. The software implementing various embodiments of the present disclosure can be stored in memory 403 and executed by processor(s) 401. A computer-readable medium can include one or more memory devices, according to particular needs. Memory 403 can read the software from one or more other computer-readable media, such as mass storage device(s) 435 or from one or more other sources via communication interface. The software can cause processor(s) 401 to execute particular processes or particular parts of particular processes described herein, including defining data structures stored in memory 403 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

1. A method for video decoding comprising:
decoding, with one or more decoding devices, information comprising a description of a layer hierarchy comprising, for each layer, a layer_id, a reference_layer_id, and a dependent_flag;
decoding for at least one access unit, a plurality of layer_not_present_flags, where each layer_not_present_flag is associated with at least one layer and
decoding Slice Network Abstraction Layer (NAL) units belonging to those layer(s) where the associated layer_not_present flag is not set.

2. The method of claim 1, wherein,
Inter-layer prediction between a first layer and a third layer is performed when a layer_not_present_flag associated with second layer is set and, in the layer hierarchy, the third layer depends on the second layer and the second layer depends on the first layer.

3. The method of claim 1, wherein the layer_not_present_flags are placed in at least one of a layer not present NAL unit, Access Unit Delimiter NAL unit, GOP header, Picture header, Slice header, or Parameter Set.

4. A system for video communication comprising:
an encoding device;
a Media Aware Network Element (MANE) coupled to the encoding device; and
a decoding device coupled to the MANE;
wherein:
the encoding device is configured to create and send a first scalable bitstream comprising a layer hierarchy and, for at least one access unit, at least one layer_not_present_flag;
the MANE is configured to receive the first scalable bitstream from the encoder, and create and send a second scalable bitstream to the decoder;
and
the decoding device is configured to decode the second scalable bitstream.

5. The system of claim 4, wherein the MANE is further configured to remove at least one layer in one access unit and indicate the removal by setting at least one associated layer_not_present_flag for that access unit.

6. The system of claim 4, wherein the encoding device, for at least one access unit, is configured to:
not encode a second layer that, in accordance with the layer hierarchy, is a layer used for inter-layer prediction by a first layer, and
indicate the absence of the second layer by setting a layer_not_present_flag associated with the second layer.

7. The system of claim 6, wherein the decoding device is configured to use a third layer for inter-layer prediction of the first layer.

8. A non-transitory computer readable medium comprising a set of executable instructions to direct a processor to perform the methods in one of claim 1-3.
